(19) United States
(12) Patent Application Publication
(10) Pub. No.: US 2023/0237225 A1
(43) Pub. Date: Jul. 27, 2023

(54) MACHINE LEARNING BASED RESERVOIR MODELING

(71) Applicant: ConocoPhillips Company, Houston, TX (US)

(72) Inventors: Chung-Kan Huang, Houston, TX (US); Qing Chen, Houston, TX (US)

(21) Appl. No.: 18/100,928

(22) Filed: Jan. 24, 2023

Related U.S. Application Data
(60) Provisional application No. 63/302,322, filed on Jan. 24, 2022.

(51) Int. Cl. G06F 30/27

(52) U.S. Cl. CPC G06F 30/27

(57) ABSTRACT

Systems and methods for reservoir modeling use reservoir simulation and production data to predict future production for one or more wells. The system receives static data of a reservoir or well, receives dynamic data of the reservoir or well, and processes the static data and the dynamic data to generate a reservoir model. For instance, the static data and dynamic data can be used to generate a Voronoi grid, which is used to create a spatio-temporal dataset representing time steps for a focal well and offset wells. The reservoir model can predict reservoir performance, field development, production metrics, and operation metrics. By using one or more Machine Learning (ML) models, the systems disclosed herein can determined reservoir physics in minutes and replicate the physical properties calculated by more complex and computationally intensive reservoir modeling.

### CROSS-REFERENCE TO RELATED APPLICATIONS

The present application claims priority to U.S. Provisional Patent Application No. 63/302,322 filed on Jan. 24, 2022, which is incorporated by reference in its entirety herein.

### FIELD

The presently disclosed technology relates to modeling reservoirs and more particularly to modeling reservoirs using a machine learning model.

### BACKGROUND

Conventional reservoir management is highly computationally inefficient, costly, and time-consuming. A given reservoir can have many variables that make management of reservoirs difficult. It is with these observations in mind, among others, that various aspects of the present disclosure were conceived and developed.

### SUMMARY

Implementations described and claimed herein address the foregoing problems by providing presently disclosed technology systems, apparatuses, methods, computer readable medium, and circuits for modeling reservoirs. In one implementation, a method includes receiving static data of a reservoir, receiving dynamic data of the reservoir, processing the static data and the dynamic data, and generating a reservoir model, wherein the reservoir model includes reservoir performance, field development, production metrics, and operation metrics.

In another implementation, a non-transitory computer readable medium is provided. The non-transitory computer readable medium can include instructions. The instructions, when executed by a computing system, can cause the computing system to receive static data of a reservoir, receive dynamic data of the reservoir, process the static data and the dynamic data, and generate a reservoir model, wherein the reservoir model includes reservoir performance, field development, production metrics, and operation metrics.

In another implementation, a system for modeling reservoirs is provided that includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the one or more processors to receive static data of a reservoir, receive dynamic data of the reservoir, process the static data and the dynamic data, and generate a reservoir model, wherein the reservoir model includes reservoir performance, field development, production metrics, and operation metrics.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

In order to describe the manner in which the above-recited and other advantages and features of the presently disclosed technology can be obtained, a more particular description of the principles briefly described above will be rendered by reference to specific example implementations thereof which are illustrated in the appended drawings. Understanding that these drawings depict only exemplary implementations of the presently disclosed technology and are not therefore to be considered to be limiting of its scope, the principles herein are described and explained with additional specificity and detail through the use of the accompanying drawings in which:

FIG. 1 depicts an example reservoir having multiple wells;

FIG. 2 depicts a block diagram illustrating an example environment having a machine learning model, which can be used with the reservoir of FIG. 1;

FIG. 3 depicts a flowchart of an example method for modeling a reservoir, which can form at least a portion of the environment of FIGS. 1 and 2;

FIG. 4 depicts an example computing system for implementing aspects of the present technology, which can form at least a portion of the systems, methods, and environments depicted in FIGS. 1-3.

FIG. 5 depicts an example system for training and using a machine learning model to generate a reservoir model, which can form at least a portion of the systems, methods, and environments depicted in FIGS. 1-4;

FIG. 6 depicts an example system for using a Voronoi polygon grid to form a spatio-temporal dataset, which can form at least a portion of the systems, methods, and environments, depicted in FIGS. 1-5;

FIG. 7 depicts an example system including a spatio-temporal data set representing time instances of a focal well, which can form at least a portion of the systems, methods, and environments depicted in FIGS. 1-6;

FIG. 8 depicts an example system for training a machine learning model, which can form at least a portion of the systems, methods, and environments, depicted in FIGS. 1-7; and

FIG. 9 depicts an example system for using recursive calculations to predict production for a well over a given period of time, which can form at least a portion of the systems, methods, and environments depicted in FIGS. 1-8.

### DETAILED DESCRIPTION

Reservoir management can be complex, inefficient, and time-consuming. Some implementations of reservoir management can include numerical reservoir simulation for modeling reservoir performance and can be used as reservoir management tools. This workflow involves model calibration or history matching, production and/or economics optimization, and uncertainty analysis, all of which involve numerous simulation runs. Additionally, numerical reservoir simulation can be high in computation costs due to complex geology, complex physics, complex well trajectory, complex operation controls, many modifications, all of which result in a highly nonlinear model. For example, a typical numerical reservoir simulation can take hours or days per run for a full field model, depending on the model size. Furthermore, it can take months to obtain a satisfactory history match (e.g., after many numerical reservoir simulation runs). Moreover, optimization can also involve thousands of simulations, which results in the usage of a large amount of computation resources and time to achieve actionable results. Such high intensity of computation limits the practical applications of numerical reservoir simulation and makes the reservoir simulation an inefficient tool for reservoir management. For instance, a Reservoir Model (RM) simulation providing detailed information can take days or weeks to run depending on the complexity and size of the model.

The presently disclosed technology involves systems and methods for generating a reservoir simulation to predict future production. By using one or more Machine Learning (ML) models, the systems disclosed herein can obtain the reservoir physics in minutes and replicate the physical properties calculated by the more complex and intensive reservoir modeling. The system can use multiple, individual time steps for each well as a separate instance for the ML model.

As an initial step, the system can obtain a Reservoir Model (RM) Simulation for a reservoir. This step can include creating a first generated grid for the RM Simulation, which can be a coarse grid or fine grid.

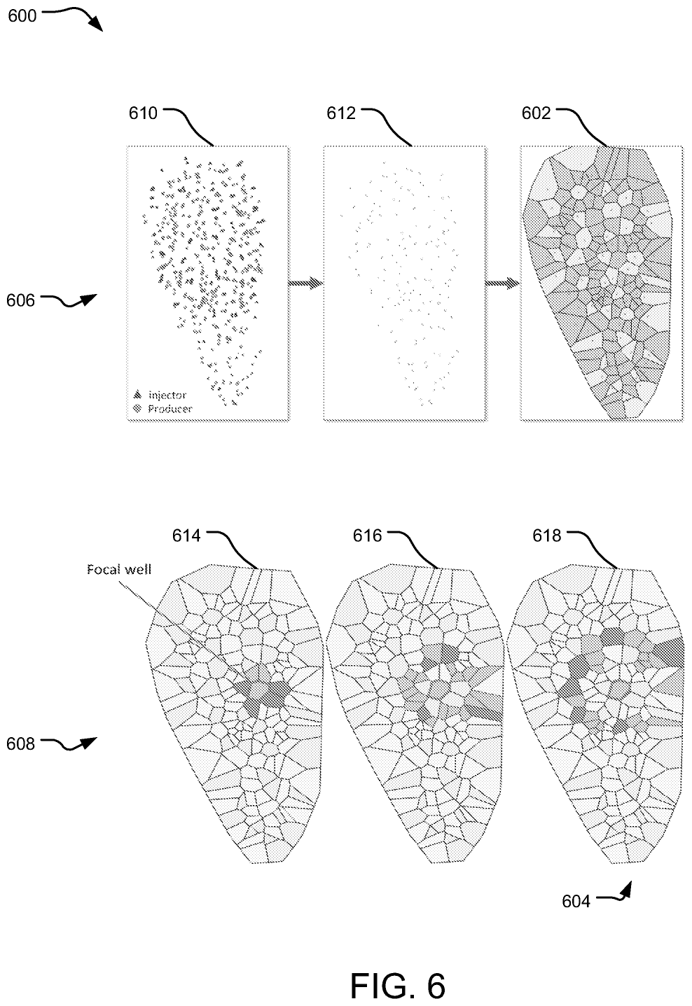

Next, the system can generate one or more Voronoi grids (e.g., which can be a second or separate grid from the first generated grid) with each Voronoi grid unique in time dependent upon the number of wells at that time. Each Voronoi grid can have spatio-temporal data based on the Voronoi grid shape at that time. The Voronoi grid changes every time a well is added to the data set because the polygonal shapes of the Voronoi grid are centered on the wells present at the time the particular Voronoi grid is generated. Thus, the Voronoi grid is time dependent (as discussed in greater detail below regarding FIG. 6).

In some examples, spatial and temporal data are obtained for the Voronoi grid. The properties for each Voronoi grid can be assembled based on the aggregate of the physical properties from a fine simulation grid and the production or injection data for a given well. Moreover, the ML properties of the ML model can be trained from the data at each timepoint not only for the given Voronoi grid, but also based on the properties of surrounding or “offset” cells leading to a dynamic modification of parameters (e.g., as discussed regarding FIG. 6).

The Polygonal cells of the Voronoi polygon grid can capture a number of dynamic properties including field history, potential drainage or irrigation area, and better predict target variables for a given well. This data can be captured as the spatio-temporal data set. Once a model is perfected (e.g., optimized within a predefined minimal error range), it can provide a quick and accurate way to predict target properties. Because the ML model is much faster than a reservoir simulation, an oil producer can use ML to model a large number of scenarios that would be time and computer intensive using traditional methods. Well locations can be moved, characterized as injection wells or production wells at different locations, and global modifications to reservoir development can be made, leading to optimization of field production.

As such, the systems disclosed herein can use a large variety of different variables and scenarios for reservoirs, training and/or inputting the variables into a machine learning model, and generating a reservoir model with significantly improved results. Various other benefits will become apparent from the disclosure below.

It should be understood, however, that the detailed description and the specific examples, while indicating the preferred examples, are given by way of illustration only and not by way of limitation. Various substitutions, modifications, additions and/or rearrangements within the spirit and/or scope of the underlying inventive concept will become apparent to those skilled in the art from this disclosure.

### I. Terminology

A well sequence can include an assignment of one or more drilling wells to one or more drilling pads, drilling and/or fracturing schedules, and/or calculated values (e.g., forecasted revenue, for instance, revenue based on production, capital expenditures, for instance, expenditures to drill a new well and prepare the well for operation, operating expenditures, for example, expenditures to operate a well, and/or degradation risks, for example, risk associated with neighboring wells, etc.).

A reservoir model is a simulated model that can be used as a realistic and highly utilized reservoir management tool. The reservoir model can also be used as a proxy model for reservoir simulation. Additionally, the reservoir model can be used to forecast production, operations, efficiency, and other statistics for reservoirs.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but can include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Further, any one of the features in the present description may be used separately or in combination with any other feature. For example, references to the term “implementation” means that the feature or features being referred to are included in at least one aspect of the present description. Separate references to the term “implementation” in this description do not necessarily refer to the same implementation and are also not mutually exclusive unless so stated and/or except as will be readily apparent to those skilled in the art from the description. For example, a feature, structure, process, step, action, or the like described in one implementation may also be included in other implementations, but is not necessarily included. Thus, the present description may include a variety of combinations and/or integrations of the implementations described herein. Additionally, all aspects of the presently disclosed technology as described herein are not essential for its practice.

### II. General Architecture and Operations

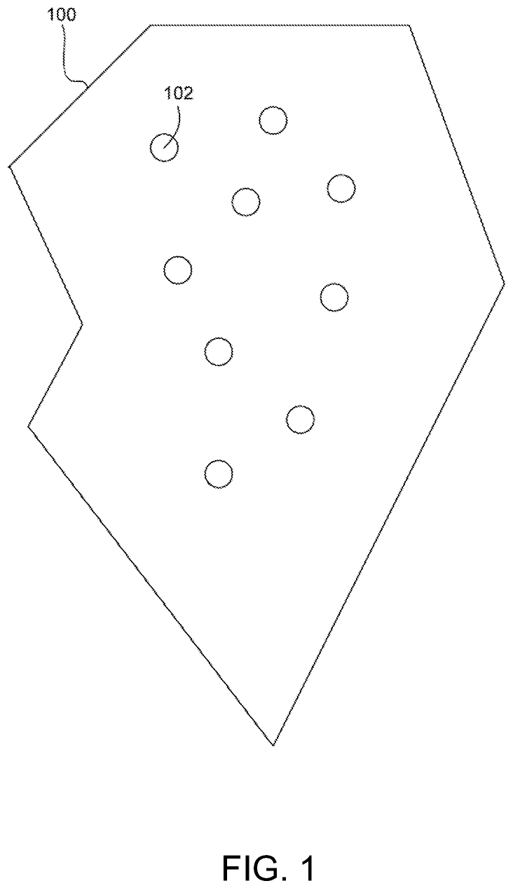

FIG. 1 illustrates a reservoir 100 having multiple wells 102. Reservoir 100 is an area containing hydrocarbons that may be contained in porous or fractured rock formations.

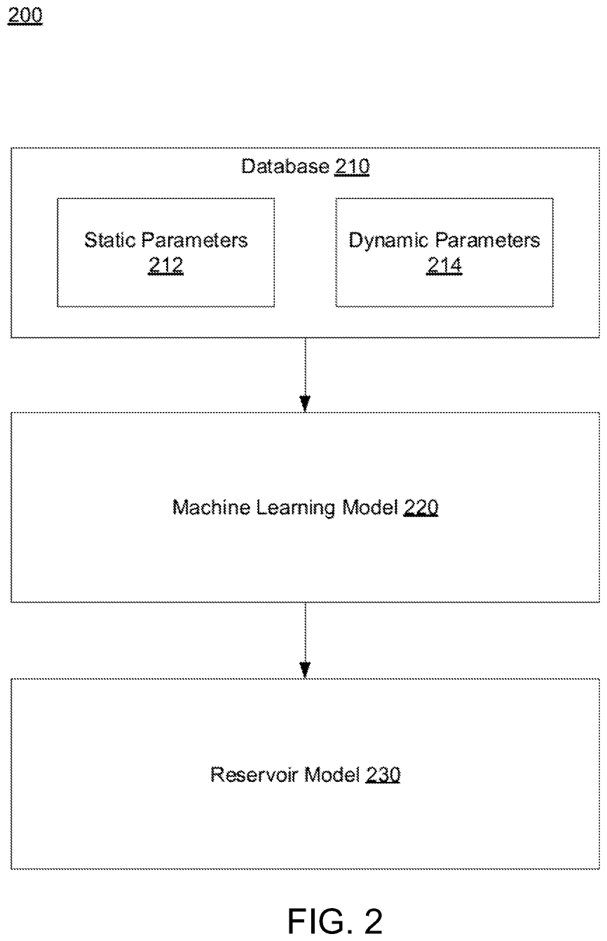

FIG. 2 illustrates a block diagram illustrating an example environment 200 having a database 210, a machine learning model 220, and a reservoir model 230.

Database 210 can be configured to store various data that can be utilized in machine learning model 220. Data stored in database 210 can be configured to represent instants of reservoir behavior in both space and time. Thus, database 210 can be configured to be a spatio-temporal database. For example, each row can represent one time-step in a life of a well and/or reservoir, while each column can represent a static or dynamic characteristic of fluid flow through porous media. In other words, data in database 210 can be various parameters including, but not limited to, static parameters 212 and dynamic parameters 214. Furthermore, each cell (e.g., cross-section between a row and a column) can include a simulation grid and/or a polygon grid. The simulation grid can be configured to demonstrate well based data (e.g., static parameters 212 and/or dynamic data 214). The polygon grid can be configured to capture and/or identify area data associated with development of reservoirs and wells (e.g., data associated with a drainage area of a well and/or reservoir). Additionally, the polygon grid can be configured to identify connections of various polygons to determine offset wells in an area (e.g., an existing wellbore that can be used as a guide for planning a well). Additionally, database 210 can include target parameters that can be used and/or obtained by machine learning model 220. For example, target parameters can include a target oil production rate (Qₒ), a target gas production rate (Q_{g}), a target water production rate (Q_{w}), a target pressure (P) a target saturation (S), a target temperature (T), and/or combinations thereof.

Static parameters 212 can be measurements and/or well or reservoir characteristics that are not expected to change with time. For example, static parameters 212 can include, at a well location, formation top, thickness of the formation, porosity, permeability, water saturation, initial pressure, porosity-thickness (PhiH), saturation-porosity-thickness (SoPhiH), etc. The static parameters 212 can provide resolution in space for the machine learning model 220 and the reservoir model 230.

Dynamic parameters 214 can be parameters that are a function of time and/or measurements that are expected to change over time. For example, dynamic parameters 214 can include oil production rate, gas production rate, water production rate, gas/oil ratio, water cut, water and gas injection, bottomhole pressure, days of production, changes in completion, operational constraints, etc. The dynamic parameters 214 can provide resolution in time for the machine learning model 220 and the reservoir model 230.

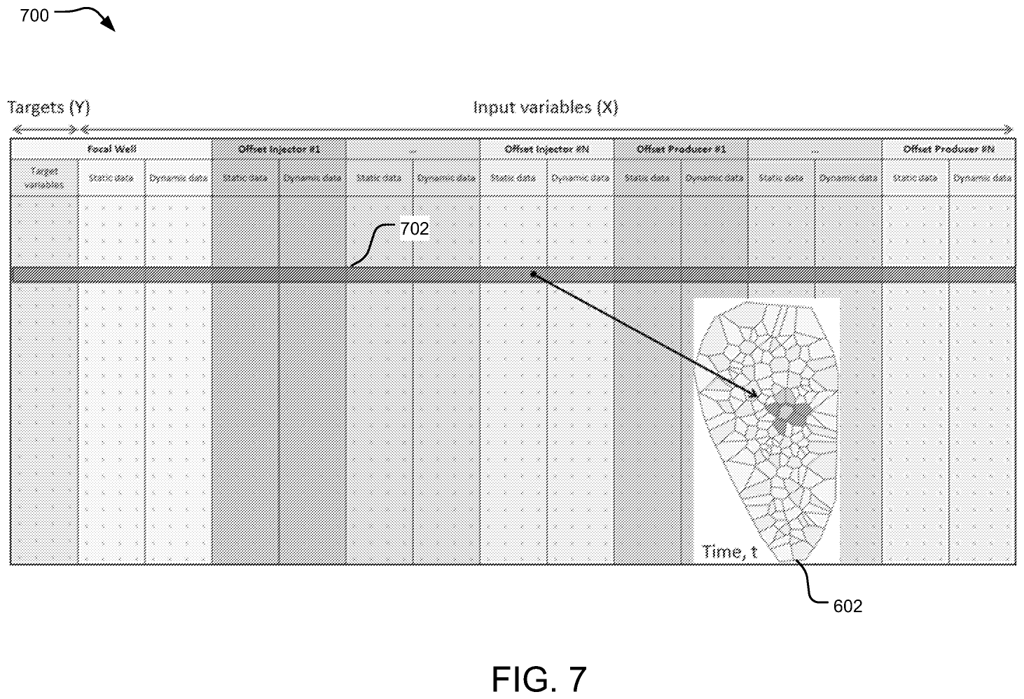

It is further contemplated that database 210 can include dynamically modified static parameters. Dynamically modified static parameters are calculated parameters based on both dynamic and static parameters. For example, dynamically modified static parameters can include averages of a given area over time (e.g., formation top, thickness, porosity, permeability, water saturation, initial pressure, PhiH, SoPhiH, etc.). In some examples, the dynamically modified parameters can be determined based on the spatio-temporal dataset 604, as discussed in greater detail below regarding FIGS. 6 and 7.

In some implementations, static parameters 212, dynamic parameters 214, and/or dynamically modified static parameters are obtained by simulating reservoir simulations. Thus, static parameters 212, dynamic parameters 214, and/or dynamically modified static parameters can be simulated parameters. It is to be understood that static parameters 212, dynamic parameters 214, and/or dynamically modified static parameters can be parameters obtained through simulation and/or through real world field data of a well and/or reservoir. Additionally, static parameters 212, dynamic parameters 214, and/or dynamically modified static parameters can be used in initial reservoir simulation runs to generate resulting data or variables of interest (e.g., tuning parameters, operational parameters including, but not limited to, infill well locations, drawdown strategy, etc.) to train machine learning model 220.

Machine learning model 220 can be a deep neural network or a gradient boost tree configured to receive inputs (e.g., static parameters 212, dynamic parameters 214, dynamically modified static parameters, and/or resulting data). Machine learning model 220 can then be trained based on the static parameters 212, dynamic parameters 214, dynamically modified static parameters, and/or the resulting data to learn well and reservoir dynamics. Machine learning model 220 can then utilize the learned well and reservoir dynamics to recursively compute reservoir model 230 based on the received inputs. For example, a first run through machine learning model 220 can identify values of desired parameters to find and/or narrow. Subsequent runs through machine learning model 220 can then be updated with desired parameters to confirm history matching or optimization results. In situations where results are unsatisfactory, additional runs through machine learning model 220 can then be reiterated until desired values are met. For example, a desired value may be a match with a historical well (e.g., a previous well) or a threshold value for oil production, gas production, water production, reservoir pressure, water saturation, etc.

It is further contemplated that other data can be utilized to train machine learning model 220. For example, field data and simulation data can both be utilized to train machine learning model 220. Field data can be field measurements such as, but not limited to, seismic surveys, well construction, well logs, core analysis, well tests, completion/workover, operational constraints, injection history, production history, etc. Furthermore, the field data can be used to generate a geological model, which can also be used additionally or alternatively to the field data to generate a numerical simulation model (e.g., a simulation model that simulates reservoirs). Machine learning model 220 can receive the field data, geological model, and/or numerical simulation model and learn well and reservoir dynamics therefrom.

Machine learning model 220 can be configured to recursively learn, update, and forecast reservoir models 230. For example, machine learning model 220 can utilize initial historical data associated to a well and/or area, receive input data for a first time-step after the historical data, and forecast a predicted variable of interest. Then, machine learning model 220 can receive input data for a second time-step after the historical data (e.g., additional data chronologically after the input data for the first time-step after the historical data) and forecast the predicted variable of interest again. Machine learning model 220 can then compare the input data for the second time-step after the historical data against the initially predicted variable of interest. Based on the comparison, machine learning model 220 can then re-associate the different input data, historical data, and predicted variables of interest to optimize accuracy and precision. In other words, machine learning model 220 can refine associations to be more accurate and precise until the machine learning model provides a perfect proxy for variables of interest. For example, machine learning model 220 can utilize formula (1) below to sequentially and/or recursively identify, determine, and/or concurrently update target variables, such as the variables in formula (2) below.

Y^{t}=F([X^{(t-1)},X^{t},X^{t},X^{(t*)}]) (1)

Here, X^{t-1} can be a predicted value from a previous time step, X^{t} is input data for a current time step, and X^{t}* is initial or historical data associated to the well or area. Using the following target variables gives formula (2): Qₒ is the target oil production rate, Q_{g} is the target gas production rate, Q_{w} is the target water production rate, and P is the target pressure.

Y^{t}=[Qₒ^{t},Q_{w}^{t},Q_{g}^{t},P^{t}] (2)

Additionally, machine learning model 220 can identify features using formula (3) below, where BHP is bottom hole pressure, X^{t-1} is a predicted data from last time step, X^{(t-1)}* is input data for the last time step, X^{t} is input data from the current time step, and X^{t}* is initial or historical data associated to the well or area.

[X^{t-1},X^{(t-1)}*,X^{t},X^{t}*]=[Qₒ^{t-1},Q_{w}^{t-1},Q_{g}^{t-1},P^{t-1},BHP^{t-1},BHP^{t},Q_{o,εf}^{t-1},Q_{w,εf}^{t-1},Q_{g,εf}^{t-1},Q_{wi,εf}^{t-1},Q_{wi,εf}^{t},X^{t}*] (3)

Reservoir model 230 is a simulated model of a reservoir based on static parameters (e.g., static parameters 212), dynamic parameters (e.g., dynamic parameters 214), and/or dynamically modified static parameters. More specifically, reservoir model 230 provides a forecast of various features of a reservoir. For example, reservoir model 230 can provide, based on received inputs of a reservoir, forecasted oil production, gas production, water production, reservoir pressure, water saturation, etc. of the reservoir. Thus, reservoir model 230 can be used as a tool to facilitate reservoir management.

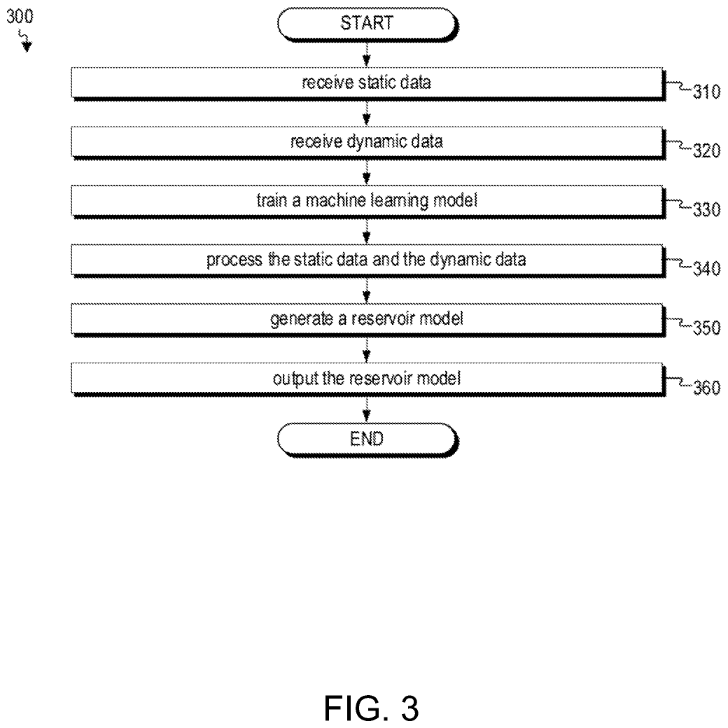

FIG. 3 illustrates an example method 300 for modeling reservoirs. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

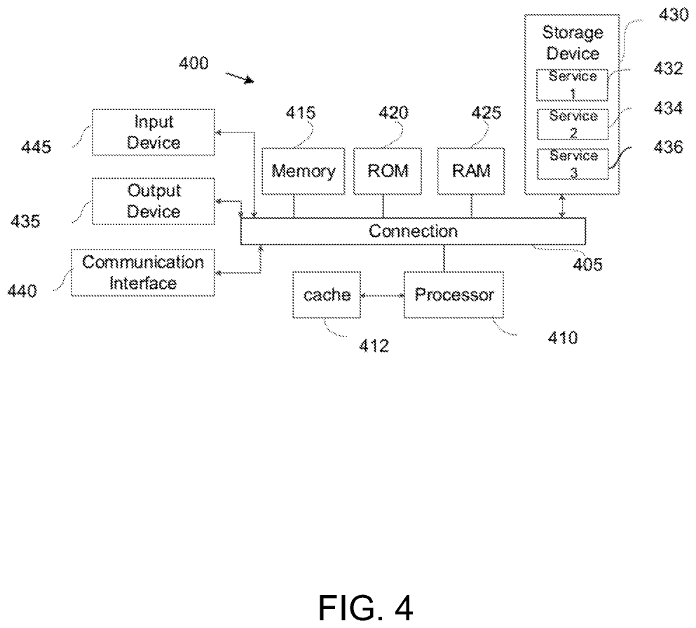

At step 310, method 300 includes receiving static data of a reservoir. For example, a computing device (e.g., computing system 400 as will be described below with respect to FIG. 4) may receive static data of a reservoir.

At step 320, method 300 includes receiving dynamic data of a reservoir. For example, a computing device (e.g., computing system 400 as will be described below with respect to FIG. 4) may receive dynamic data of a reservoir. In some implementations, the static data and dynamic data include both field data and data obtained in a simulation of the reservoir. In some implementations, the static data and the dynamic data is stored in and/or received from a spatio-temporal database. Additionally, in some implementations, the spatio-temporal database associates the static data and the dynamic data with a point in time. Moreover, the spatio-temporal database can include data of the reservoir from a plurality of points in time. In some implementations, the spatio-temporal database includes a simulation grid and/or a polygon grid. In these implementations, the simulation grid can be associated with the static and dynamic data. Additionally, the polygon grid can be associated with drainage areas of the reservoir. In some implementations, the static data and the dynamic data respectively are consecutive data to historical static data and historical dynamic data. For example, the static data and the dynamic data can be data for next time-steps of the historical static data and the historical dynamic data, respectively.

In some implementations, method 300 includes training a machine learning model based on the static data and the dynamic data at step 330. For example, a computing system (e.g., computing system 400 as will be described below with respect to FIG. 4) may train a machine learning model based on the static data and the dynamic data. In some implementations, the machine learning model can additionally be trained based on historical static data and historical dynamic data.

At step 340, method 300 includes processing the static data and the dynamic data to identify centroids of wells in the reservoir. Furthermore, method 300 can include generating polygons based on the centroids of the wells in the reservoir. Additionally, that may be dynamically modified. For example, a computing system (e.g., computing system 400 as will be described below with respect to FIG. 4) may process the static data and the dynamic data. In some implementations, processing the static data and the dynamic data includes inputting the static data and the dynamic data into a machine learning model. Thus, the machine learning model may process the static data and the dynamic data.

At step 350, method 300 includes generating a reservoir model based on the polygons, static data, and/or dynamic data. For example, a computing system (e.g., computing system 400 as will be discussed below with respect to FIG. 4) may generate a reservoir model. The reservoir model includes reservoir performance, field development, production metrics, and operation metrics.

At step 360, method 300 includes outputting the reservoir model. For example, a computing system can output the reservoir model on a display (e.g., output device 435 as will be discussed below with respect to FIG. 4).

FIG. 4 shows an example of computing system 400, which can be for example any computing device configured to implement method 300, or any component thereof in which the components of the system are in communication with each other using connection 405. Connection 405 can be a physical connection via a bus, or a direct connection into processor 410, such as in a chipset architecture. Connection 405 can also be a virtual connection, networked connection, or logical connection.

In some implementations, computing system 400 is a distributed system in which the functions described in this disclosure can be distributed within a datacenter, multiple data centers, a peer network, etc. In some implementations, one or more of the described system components represents many such components each performing some or all of the function for which the component is described. In some implementations, the components can be physical or virtual devices.

Example system 400 includes at least one processing unit (CPU or processor) 410 and connection 405 that couples various system components including system memory 415, such as read-only memory (ROM) 420 and random access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. There is no restriction on operating on any particular hardware arrangement, and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 430 can include software services, servers, services, etc., that when the code that defines such software is executed by the processor 410, it causes the system to perform a function. In some implementations, a hardware service that performs a particular function can include the software component stored in a computer-readable medium in connection with the necessary hardware components, such as processor 410, connection 405, output device 435, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some implementations, a service can be software that resides in memory of a client device and/or one or more servers of a content management system and perform one or more functions when a processor executes the software associated with the service. In some implementations, a service is a program or a collection of programs that carry out a specific function. In some implementations, a service can be considered a server. The memory can be a non-transitory computer-readable medium.

In some implementations, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

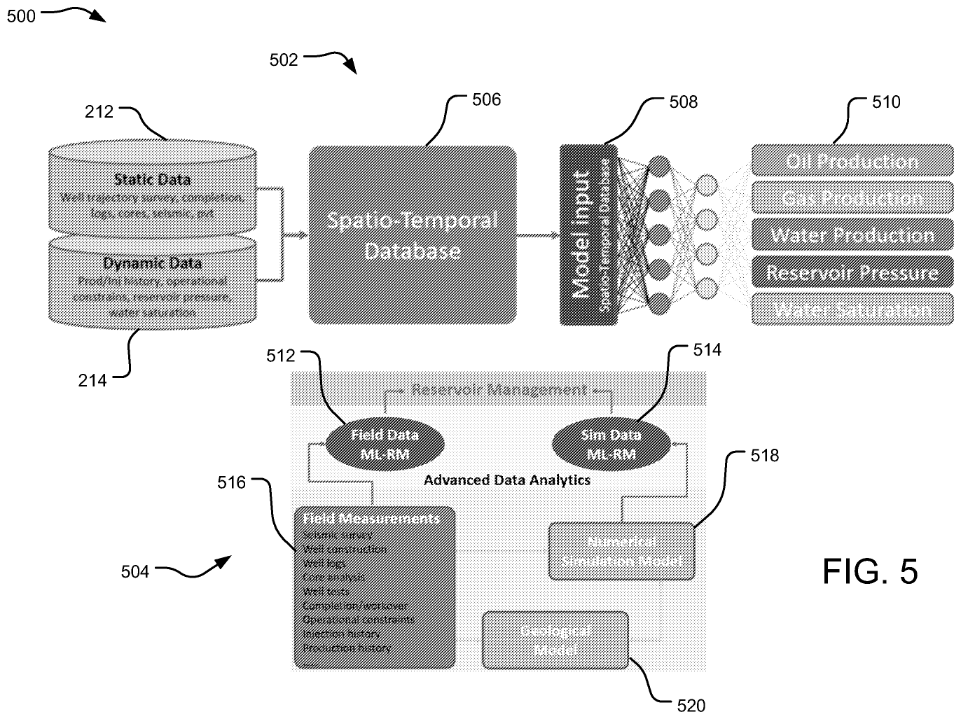

Turning to FIG. 5, an example system 500 for training and using the machine learning model 220 to generate the reservoir model 230 is depicted, which can form at least a portion of the systems, methods, and environments, depicted in FIGS. 1-4. The system 500 can include a ML system 502 and/or a reservoir management system 504.

In some examples, the ML system 502 includes a data flow with the static parameters 212, the dynamic parameters 214, and/or the dynamically modified static parameters combined into a spatio-temporal dataset 506. The spatio-temporal dataset 506 can be provided as model input 508 to a ML training system (e.g., using a neural network and/or gradient boost tree), which outputs the target variables 510 (e.g., an oil production rate, a gas production rate, a water production rate, a reservoir pressure, a water saturation, and the like). These steps are discussed in greater detail below regarding FIGS. 6-9.

The reservoir management system 504 can receive and/or aggregate data from a first machine learning reservoir model (ML-RM) 512 (e.g., based on field data) and a second ML-RM (e.g., based on simulated results data) 514. For instance, the first ML-RM 512 can be based on field measurements 516, such as a seismic survey, well construction, well logs, core analysis, well tests, completion/workover information, operational constraints information, injection history, production history, and the like. The second ML-RM 514 can be based on a numerical simulation model 518, such as the outputted target variables and/or recursive calculation results discussed herein, and the like. The numerical simulation model 518 can, in turn be based on the field measurements 516 and/or a geological model 520 (e.g., which can also be based on the field measurements 516).

FIG. 6 depicts an example system 600 to generate a Voronoi polygon grid 602 to form a spatio-temporal dataset 604 (e.g., the spatio-temporal dataset 506 of FIG. 5), which can form at least a portion of the systems, methods, and environments, depicted in FIGS. 1-5. The system 600 can include a polygon generating procedure 606 and/or an offset well tiering procedure 608

In some examples, the polygon generating procedure 606 generates a plurality of Voronoi grids by determining well location data 610, which can include injector well locations and/or producer well locations, and can be based on the static parameters 212, and the dynamic parameters 214. Then the polygon generating procedure 606 can convert the well location data 610 into polygon centroid data 612, such that the well location data is converted into center points for to-be-formed polygons. Finally, the Voronoi polygon grid 602 is formed from the polygon centroid data 612 by calculating polygon sides between the centroids to generate polygon-based data. The polygons can be associated with the type of well included in the location data 610 (e.g., injector or producer).

The Voronoi polygon grid 602 can include polygon-based data that is dynamically modified. For instance, the Voronoi polygon grid 602 can change every time a well is added to the data set (e.g., the well location data 610) because the polygonal shapes of the Voronoi grid are centered on the wells present at the time the particular Voronoi polygon grid 602 is generated. Thus, the Voronoi polygon grid 602 can be time dependent. With the Voronoi polygon grid 602 being unique in time dependent upon the number of wells at that time, multiple Voronoi polygon grid 602 can be generated with spatio-temporal data based on the Voronoi grid shape at that time. In some instances, the properties for each Voronoi grid are assembled based on the aggregate of the physical properties from a fine simulation grid and the production or injection data for a given well.

Moreover, using the offset well tiering procedure 608, the ML properties of the ML model can be trained from the data at each timepoint not only for the given Voronoi grid, but also based on the properties of surrounding cells leading to a dynamic modification of parameters. For instance, the offset well tiering procedure 608 can include determining a first tier of offset wells 614 by determining neighbors for the focal well (e.g., polygons that share a polygon side with the focal well). A second tier of offset wells 616 can be determined to include neighbors of the neighbors, or polygons that share a polygon side with the first tier of offset wells 614. Additionally, the offset well tiering procedure 608 can determine a third tier of offset wells 618 including polygons/cells with wells that are neighbors of neighbors of neighbors (e.g., third order neighbors) of the focal well. the spatio-temporal dataset 604 can include a fourth tier, a fifth tier, etc. of offset wells using similar techniques.

These categorization of the wells into the different tiers can be used to generate the spatio-temporal data 604. This improves results for reservoir modeling because the polygonal cells capture a number of dynamic properties including field history, potential drainage or irrigation areas, and better predict target variables for a given well. The reservoir properties for the cell can be aggregated from the underlying reservoir model grid (e.g., the static parameters 212) and monthly production rates provided for the well (e.g., the dynamic parameters 214). Because the cells change as new wells are added, the cells are dynamically modified (e.g., to create the dynamically modified static parameters discussed above). Moreover, using the polygon generating procedure 606 and the offset well tiering procedure 608 to generate the Voronoi polygon grid 602 can be used for improvements to horizontal wells, faults, and layering scenarios.

FIG. 7 depicts an example system 700 including the spatio-temporal data set 604 representing time instances of a focal well as a plurality of rows 702. The system 700 can form at least a portion of the systems, methods, and environments, depicted in FIGS. 1-6.

In some examples, the spatio-temporal dataset 604 includes records representing production behavior at a focus target well (e.g., the well at the center of a polygon) with each row including the behavior and/or production data for the focal well at a time T, which can be based on the Voronoi polygon grid 602 discussed above. The row(s) 702 can individually represent one time-step in the life of the focal well and/or the reservoir. Moreover, a plurality of columns 704 of the spatio-temporal dataset 604 can represent a plurality of static or dynamic characteristics of fluid flowing through porous media at the reservoir. In some instances, the spatio-temporal dataset 604 includes up to 30,000 rows and/or 500 columns.

For instance, the spatio-temporal dataset 604 can include focal well columns, such as a target variables column, a static data column, and a dynamic data column associated with the focal well. The static data column and the dynamic data column can include input variables for the ML model 220 with the target variables being outputs. Moreover, the spatio-temporal dataset 604 can include other input variables such as the static data and the dynamic data associated with the first tier of offset wells 614, the second tier of offset wells 616, and the third tier of offset wells 618 (e.g., based on the Voronoi polygon grid 602). Additionally, the Voronoi polygon grid 602 can include injector well columns and producer well columns.

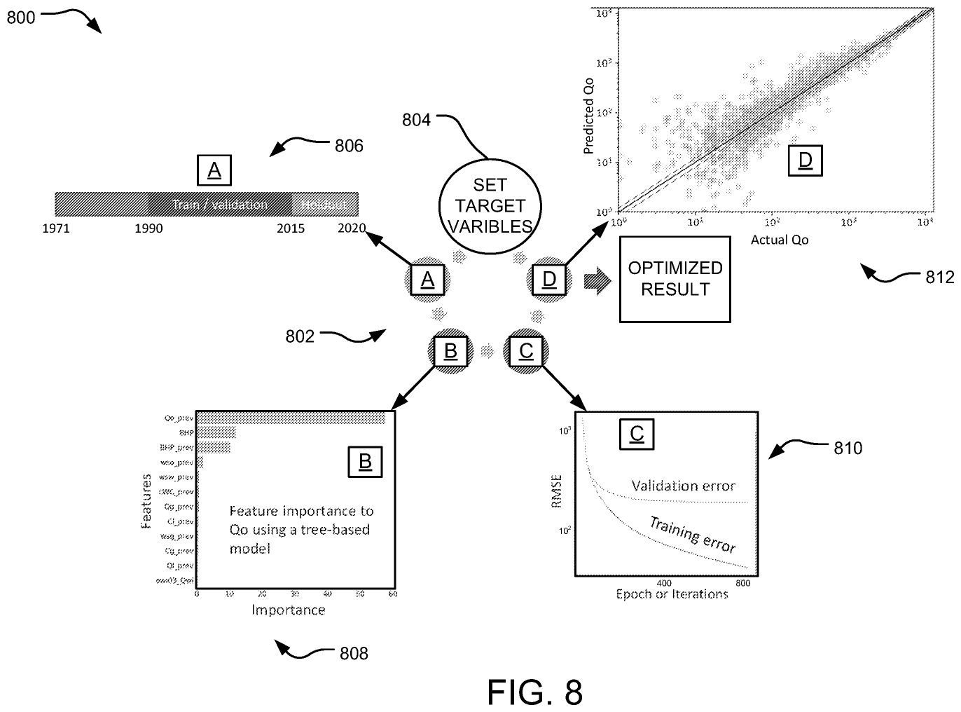

FIG. 8 depicts an examples system 800 for training the machine learning model 220, which can form at least a portion of the systems, methods, and environments, depicted in FIGS. 1-7.

In some examples, the system 800 can include a ML model training cycle 802 with multiple iterative operations. For instance, an initial operation 804 of the ML model training cycle 802 can include setting values for the target variables (e.g., Qo, Qg, Qw, P, S, T, etc.). Then the system 800 can perform a dataset splitting operation 806, for instance, to determine a first dataset or subset to use as training/validation data and/or a second a dataset or subset to use as holdout data (e.g., based on one or more cut-off dates). Additionally, the system 800 can perform a feature selection operation 808 in which feature importance to the target variable(s) is determined using a tree-based model. For instance, once a ML model has been developed a weight can be assigned to each feature in a given well matching the observed well properties to the reservoir model data. The system 800 can also perform a ML training/validation operation 810 in which a deep neural network and/or a gradient boost tree performs multiple epochs or iterations of the reservoir model 230 and validation and training errors are calculated. Following the training/validation operation 810, the ML model training cycle 802 of the system 800 can perform an evaluation operation 812. At the evaluation operation 812 the system 800 can compare actual target variables from historical data to predicted target variables generated at the training/validation operation 812. This comparison can be performed using the training data, the validation data, and/or the holdout data. After performing the evaluation operation 812, any of the operations of the ML model training cycle 802 can be repeated and/or modified in an iterative manner and an optimized result model is created. The operations of the ML model training cycle 802 may be iterated based on an accuracy or mismatch between a true and predicted value of target variables. For example, the iterations may involve achieving a particular R-squared value.

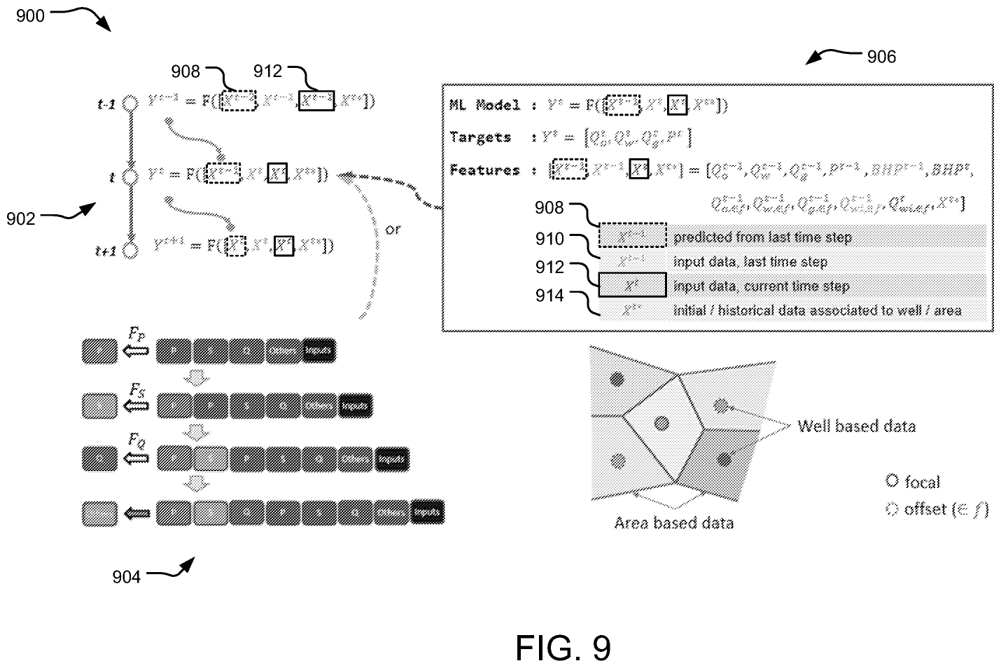

FIG. 9 illustrates an examples system 900 for using recursive calculations to predict production for a particular well (e.g., the focal well) over a given period of time. The system 900 can include a recursive solution strategy 902 using one or more sequential updates 906 and/or one or more concurrent updates 904 to generate the prediction. In this example, the one or more sequential updates 906 are a standard option while the one or more concurrent updates 904 are an alternative option. The system 900 can form at least a portion of the systems, methods, and environments, depicted in FIGS. 1-8.

For instance, the recursive solution strategy 902 can include a series of recursive calculations for different time t values (e.g., t−1, t, t+1, etc.) The series of recursive calculations can be based on a value predicted from a last time step 908, input data from the last time step 910, input data for the current time step 912, and/or initial historical data associated with the well or area 914. The one or more sequential updates 906 can provide updates for a particular target variable sequentially (e.g., a first update for the pressure target variable, a second update for the saturation target variable, a third update for a product rate target variable, etc.). Additionally or alternatively, the recursive solution strategy 902 can use the one or more concurrent updates 904, which combines the multiple target variables into a single formula so that multiple target variables can be updated with each update. Moreover, it is to be understood that the system 900 can use well-based data corresponding to the wells and area-based data corresponding to an area (e.g., a polygon cell) around the well. Additionally, the system 900 can use data directly corresponding to the focal well and data corresponding to the offset wells of the one or more tiers discussed above regarding FIGS. 6 and 7.

In some examples, by using the recursive solution strategy 902 depicted in FIG. 9, the system 900 can predict production for a particular well over a given period. This can be done for a short period with more accuracy, such as predicting production for the next month, or for a longer time period. Predictions for the longer time periods may become less accurate than shorter time periods, but the information can still be quite valuable, such as a lifetime production prediction for a proposed infill well. Once the ML model 220 is optimized within a predefined minimal error range using at least the system 500-900 disclosed herein, it can provide a quick and accurate way to predict target properties. Because the ML model 220 is significantly faster than a reservoir simulation, an oil producer can use the ML model to model a large number of scenarios that would be time and computer intensive using traditional methods. As such, the system can provide global modifications to reservoir development which can lead to optimized field production.

It is to be understood that the specific, arrangement order or hierarchy of steps or operations in the systems and methods depicted in FIGS. 1-9 are instances of example approaches and can be rearranged while remaining within the disclosed subject matter. For instance, any of the steps depicted in FIGS. 1-9 may be omitted, repeated, performed in parallel, performed in a different order, and/or combined with any other of the steps depicted in FIGS. 1-9.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method for reservoir modeling, the method comprising:
receiving static data of a reservoir from a spatio-temporal database;
receiving dynamic data of the reservoir from a spatio-temporal database;
processing the static data and the dynamic data to identify centroids of wells in the reservoir;
generating polygons based on the centroids of the well, and
generating a reservoir model based on at least one of the polygons, static data, or dynamic data, wherein the reservoir model includes reservoir performance, field development, production metrics, and operation metrics.

2. The method of claim 1, wherein processing the static data and the dynamic data includes inputting the static data and the dynamic data into a machine learning model.

3. The method of claim 1, further comprising:
training a machine learning model based on historical static data and historical dynamic data.

4. The method of claim 1, further comprising:
training a machine learning model based on the static data and the dynamic data.

5. The method of claim 1, wherein the static data and the dynamic data are stored in the spatio-temporal database, and wherein the spatio-temporal database associates the static data and the dynamic data with a point in time.

6. The method of claim 1, wherein the spatio-temporal database includes data of the reservoir from a plurality of points in time.

7. The method of claim 1, wherein the spatio-temporal database includes a simulation grid and a polygon grid, wherein the simulation grid is associated with the static and dynamic data, and wherein the polygon grid is associated with at least one of drainage areas or irrigation areas of the reservoir.

8. The method of claim 1, wherein the static data and dynamic data include both field data and data obtained in a simulation of the reservoir.

9. The method of claim 1, wherein the static data and the dynamic data respectively are consecutive data to historical static data and historical dynamic data.

10. One or more non-transitory computer readable media storing instructions, the instructions, when executed by a computing system, causing the computing system to:
receive static data of a reservoir from a spatio-temporal database;
receive dynamic data of the reservoir from a spatio-temporal database;
process the static data and the dynamic data to identify centroids of wells in the reservoir;
generate polygons based on the centroids of the wells in the reservoir; and
generate a reservoir model based on at least one of the polygons, the static data, or the dynamic data, wherein the reservoir model includes reservoir performance, field development, production metrics, and operation metrics.

11. The one or more non-transitory computer readable media of claim 10, processing the static data and the dynamic data includes inputting the static data and the dynamic data into a machine learning model.

12. The one or more non-transitory computer readable media of claim 10, wherein the computer readable medium further comprises instructions that, when executed by the computing system, cause the computing system to:
train a machine learning model based on historical static data and historical dynamic data.

13. The one or more non-transitory computer readable media of claim 10, wherein the computer readable medium further comprises instructions that, when executed by the computing system, cause the computing system to:
train a machine learning model based on the static data and the dynamic data.

14. The one or more non-transitory computer readable media of claim 10, both the static data and the dynamic data are stored in the spatio-temporal database.

15. The one or more non-transitory computer readable media of claim 14, the spatio-temporal database includes data of the reservoir from a plurality of points in time.

16. The one or more non-transitory computer readable media of claim 14, the spatio-temporal database includes a simulation grid and a polygon grid, the simulation grid is associated with the static and dynamic data, and the polygon grid is associated with drainage areas of the reservoir.

17. The one or more non-transitory computer readable media of claim 10, the static data and dynamic data include both field data and data obtained in a simulation of the reservoir.

18. A system comprising:
a storage configured to store instructions;
a processor configured to execute the instructions and cause the processor to:
receive static data of a reservoir from a spatio-temporal database;
receive dynamic data of the reservoir from a spatio-temporal database;
process the static data and the dynamic data to identify centroids of wells in the reservoir;
generate polygons based on the centroids of the wells in the reservoir; and
generate a reservoir model based on at least one of the polygons, the static data, or the dynamic data, wherein the reservoir model includes reservoir performance, field development, production metrics, and operation metrics.

19. The system of claim 18, wherein processing the static data and the dynamic data includes inputting the static data and the dynamic data into a machine learning model.

20. The system of claim 18, wherein the processor is configured to execute the instructions and cause the processor to:
train a machine learning model based on the static data and the dynamic data.
